(19) United States
(12) Patent Application Publication
(10) Pub. No.: US 2009/0310066 A1
(43) Pub. Date: Dec. 17, 2009

(54) LED tile Luminance control circuitry and display containing the same

(75) Inventors: John Schuch, Buford, GA (US); Robert Cauffield, Lawrenceville, GA (US); David Williams, Canton, GA (US); William Dunn, Alpharetta, GA (US)

Correspondence Address: STANDLEY LAW GROUP LLP, 6300 Riverside Drive, Dublin, OH, 43017, US

(73) Assignee: Manufacturing Resources International, Inc., Alpharetta, GA (US)

(21) Appl. No.: 12/274,678

(22) Filed: Nov. 20, 2008

Related U.S. Application Data
(63) Continuation-in-part of application No. 12/209,841, filed on Sep. 12, 2008.
Application No. 12/209,841 is a continuation-in-part of application No. 12/235,232, filed on Sep. 22, 2008.
(60) Provisional application No. 61/060,504, filed on Jun. 11, 2008.
(60) Provisional application No. 61/061,032, filed on Jun. 12, 2008.

(51) Int. Cl. G02F 1/13357; F21V 21/00

(52) U.S. Cl. 349/69; 362/97.1

(57) ABSTRACT

Exemplary embodiments include a backlight assembly for a display wherein the backlight assembly is comprised of a plurality of tiles. Each tile has a plurality of lights attached to it, such that when a single light or group of lights fail, the tile may be replaced without having to replace the entire backlight assembly. The current draw and/or illumination of each tile is calibrated and maintained throughout the life of the display to ensure a uniform distribution of light across the backlight assembly.

### CROSS-REFERENCE TO RELATED APPLICATIONS

This application is a continuation-in-part of co-pending application Ser. Nos. 12/209,841 filed Sep. 12, 2008, which is a non-provisional of U.S. Application No. 61/060,504 filed Jun. 11, 2008 and 12/235,232 filed Sep. 22, 2008, which is a non-provisional of U.S. Application No. 61/061,032 filed Jun. 12, 2008 and are herein incorporated by reference in their entirety.

### TECHNICAL FIELD

The various embodiments relate generally to backlight systems for displays and more specifically to backlight systems comprised of a plurality of removable tiles. Exemplary backlights normalize the illumination of the overall backlight unit by controlling the illumination level of each tile.

### BACKGROUND OF THE ART

Static and dynamic displays typically require some type of light source in order to generate an image upon a viewable screen. For static displays, the light source illuminates a non-moving graphic to enhance its visibility and attract the attention of passers-by. For dynamic displays, and specifically for liquid crystal displays (LCD's), a light source is required to shine through the crystals, where the crystals control the amount of light which will pass through by orienting themselves in response to a potential difference. This light source is typically referred to as the Back Light Unit (BLU), as this light source is placed behind the crystals and towards the back of the display assembly.

Previously, an arrangement of fluorescent lights has been used to construct the BLU for static and dynamic displays. Energy, environmental, relative size, life span, and various other concerns have prompted the display industry to seek different lighting structures to produce the backlight for displays. The industry has turned to light emitting diodes (LEDs) as the solution.

LEDs have a limited life span, and eventually their luminance will degrade until little or no luminance is generated. Some LEDs may quickly fail simply due to a manufacturing defect. Currently when this occurs in an LED backlight, the entire BLU assembly is replaced (ie. the element which every LED is mounted to is replaced with a new element containing all new LEDs). This is expensive, and is an unnecessary waste of the good LEDs which remain in the backlight. Alternatively, the LED backlight assembly could be removed from the display housing, and the degraded or faulty LEDs could be manually replaced. This is typically even more costly, and involves extensive manual labor. In currently known units, this also requires virtual complete disassembly of the display to gain access to the BLU. This complete disassembly is not only labor intensive, but in the case of an LCD, must be performed in a clean room environment and involves the handling of expensive, delicate, and fragile components that can be easily damaged or destroyed, even with the use of expensive specialized tools, equipment, fixtures, and facilities.

These problems are intensified as the modern displays, and more specifically LCDs grow larger and larger. For large displays, replacing the entire LED backlight assembly could be extremely expensive and could waste a large number of LEDs which still work properly, as well as damage or destroy the fragile LCD itself.

Co-pending application Ser. No. 12/209,841 discloses a backlight which is comprised of a plurality of light tiles, where a single tile can be replaced from the backlight, rather than having to replace the entire assembly. However, the precise level of illumination from each tile may vary based on the individual properties of the lights themselves and/or the specific mounting and circuitry of the tile once assembled. Thus, the illumination of the tiles must be controlled to provide a balanced level of illumination from the backlight.

### SUMMARY OF THE EXEMPLARY EMBODIMENTS

Exemplary embodiments comprise a backlight assembly which is constructed of multiple tiles of lights, such that a single tile may be replaced without having to replace the entire backlight assembly. Embodiments may be practiced with any number of electronic displays, both static displays and dynamic displays, where exemplary embodiments are practiced with LCD displays. Furthermore, the tiles in an exemplary embodiment may be replaced individually from the rear of the display without touching or disturbing the LCD or other delicate optical components.

The current draw of each tile is measured and controlled to provide a uniform level of illumination across all the tiles in the backlight assembly.

### BRIEF DESCRIPTION OF THE DRAWINGS

A better understanding of the exemplary embodiments of the invention will be had when reference is made to the accompanying drawings, wherein identical parts are identified with identical reference numerals, and wherein:

FIG. 1 is a front view of an LED backlight comprised of individual tiles;

FIG. 2A is a rear view of one embodiment for electrically connecting and controlling each of the tiles within an exemplary backlight;

FIG. 2B is a rear view of another embodiment for electrically connecting a tile;

FIG. 2C is a front view of an embodiment for connecting a tile from FIG. 2B;

FIG. 3A is a schematic of one embodiment for powering and controlling the lights within a tile;

FIG. 3B is a schematic of another embodiment for powering and controlling the lights within a tile;

FIG. 4 is a schematic of another embodiment for powering and controlling the lights within a tile; and

FIG. 5 is a schematic of one embodiment for an exemplary control circuit.

### DETAILED DESCRIPTION OF EXEMPLARY EMBODIMENTS

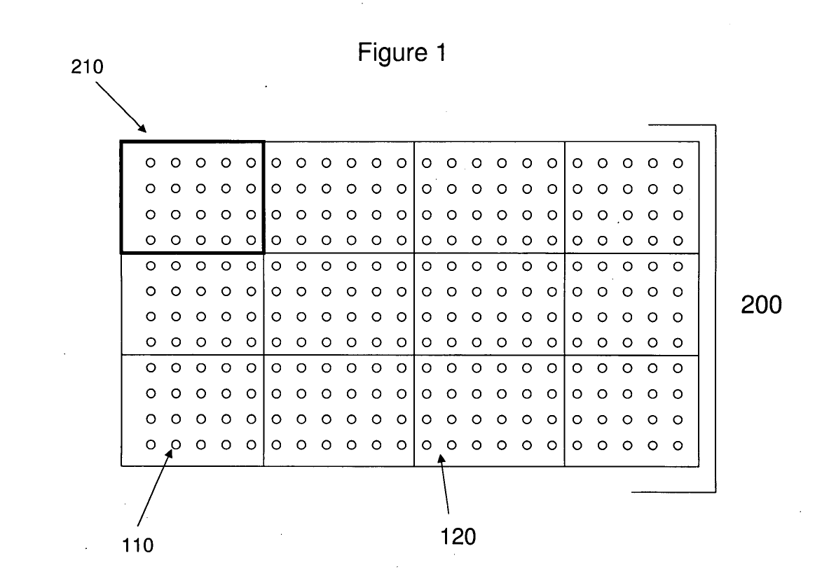

Turning to the drawings for a better understanding, FIG. 1 shows the front view of an exemplary embodiment where the backlight assembly 200 is divided into multiple tiles 210 with a number of lights 110 on each tile. These lights may be LEDs. A mounting element 120 provides the structure for which to mount the various lights 110. This mounting element 120 may be any solid structure which provides adequate securing of the lights 110, distributes power to and controls the lights 110, and may have additional layers and features which reflect light and have thermal properties. A printed circuit board could be used for this purpose or it may be one component in an assembly which would comprise the mounting element 120.

In an exemplary embodiment, the mounting element 120 may utilize metal PCB technology to dissipate heat from the lights 110 to the rear surface of the mounting element 120. In this exemplary embodiment, the rear surface of the mounting element 120 may be exposed metal, so that cool air may pass over this rear surface and further dissipate heat from the mounting element 120 and thus from the lights 110. In this exemplary embodiment, there should be a low level of thermal resistance between the chip or die which contains the lights 110 and the exposed rear metal surface of the mounting element 120.

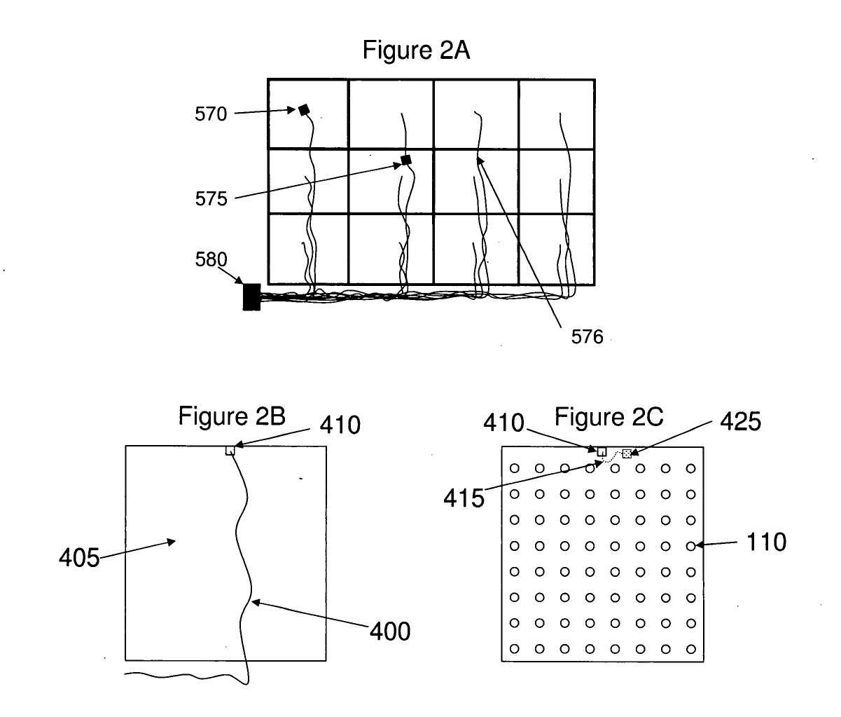

FIG. 2A shows a rear view of one embodiment for electrically connecting and controlling each of the tiles within an exemplary backlight. The electrically conductive elements 320 may be combined into a single plug 570 so that the tile may be easily connected/disconnected from the assembly. Many other methods can be used to connect the tiles. A wiring harness 575 could be placed further away from the tile itself or could be placed near a control box 580. Alternatively, the tile could be hard wired 576 with a wiring harness that plugs into the control box 580. To electrically disconnect a selected tile, the plug or wire harness is simply disconnected. The opposite would apply to connect a new tile. Note that any number of electrical connectors could be used and still fall within the teaching of this invention. Those skilled in the art can choose the precise type of connectors for the specific application and type of display.

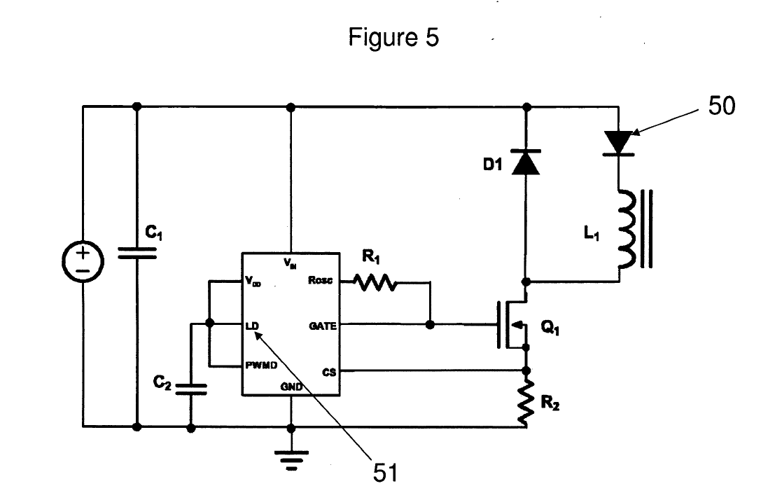

The control box 580 may contain multiple elements which measure and control the current levels in each tile. The control box 580 may also contain components and software to determine when a tile needs replaced. The control box may contain the controlling circuitry for the tiles which is shown in FIG. 5.

FIG. 2B shows another embodiment for electrically connecting a tile. In this embodiment, the wiring 400 passes through the tile 405 by traversing through the space 410. In an exemplary embodiment, the space 410 is as small as possible, so that light cannot leak into the rear of the display. FIG. 2C shows the front of the embodiment from FIG. 2B. Wiring 415 passes through the space 410 and connects to the plug 425. In an exemplary embodiment where the lights are producing white light, the wiring 415 and the plug 425 may be colored white so that any reflection of light off the surfaces of the wiring 415 or the plug 425 will not color the light coming from the lights 110. Again, any number of electrical connectors or wiring harnesses can be used to connect each tile. Connections on the front or rear of each tile may be beneficial depending on the manufacturing process, structure of the mounting element, and application of the display.

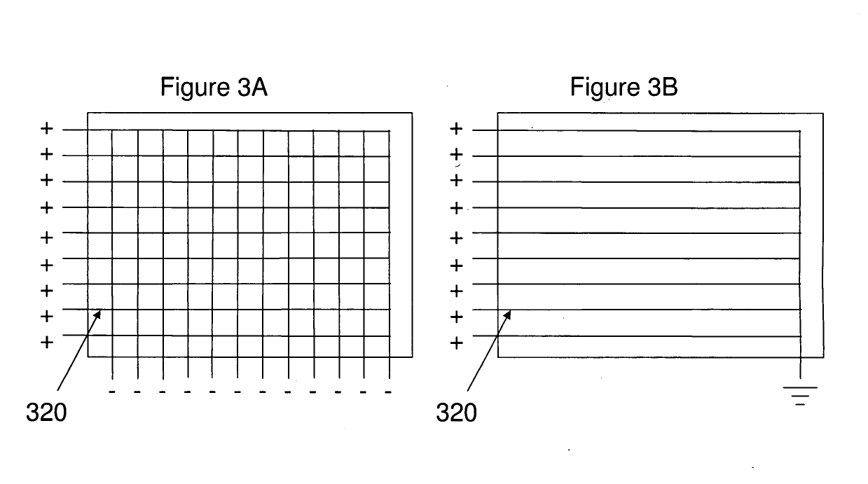

FIG. 3A shows one embodiment for electrically distributing power to and controlling the lights within a single tile. In this embodiment, a grid of electrically conductive elements 320 is mapped out across the mounting element. This grid may or may not be visible when looking at the tile, as it may be covered by several other layers of the mounting element. These electrically conductive elements may be a layer of a printed circuit board or simply one layer for a multi-layer mounting element. FIG. 3B shows another embodiment for electrically distributing power to and controlling the lights within a single tile. Again, electrically conductive elements 320 are mapped out across the mounting element. These elements may not be visible when looking at the tile.

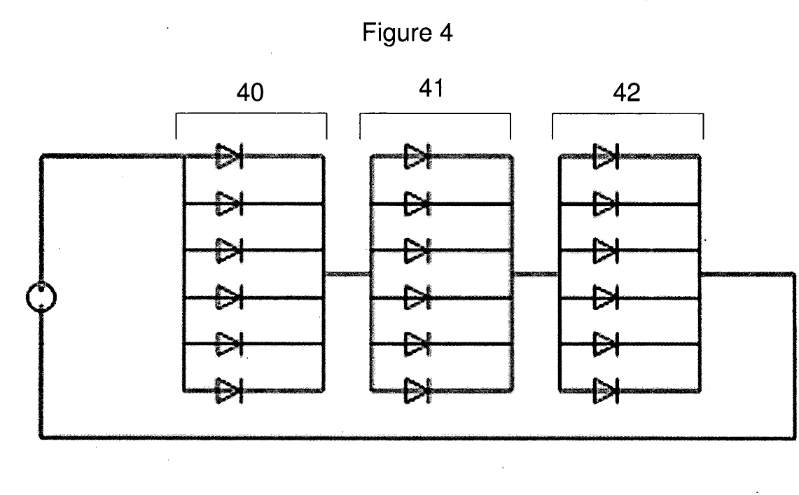

FIG. 4 shows the schematic for the parallel/series technique taught in co-pending application No. 61/061,032, herein incorporated by reference in its entirety. This embodiment for distributing power to and controlling the lights within a single tile may also be used. In this embodiment, three parallel groups 40, 41, and 42 are connected in series. There are several advantages to using the embodiment shown in FIG. 4, including but not limited to the ability of current to flow around LEDs which might fail. Thus, any LED failure would affect only a small area of luminance uniformity, and has little effect on the overall presentation. Further, since the parallel blocks of LEDs are connected in series, the current in each parallel block will be the same, resulting in the same luminance. Finally, any number of parallel/series configurations are possible, allowing for scaling to any size tile, display, as well as LED string voltage, current, and power. It should be noted that this embodiment is not limited to three parallel groupings. Any plurality of groupings would satisfy this embodiment. Further, each grouping is not limited to six LEDs, as any plurality of LEDs within the group would satisfy this embodiment.

Exemplary embodiments determine the preferred amount of current draw to achieve the desired illumination level for a tile. This preferred amount of current draw may be determined at the factory and may be specific to each tile. For example, depending on the individual characteristics of the LEDs and the manufacturing techniques, a slightly different preferred current draw may be selected for each tile in order to achieve luminance uniformity. This current draw may be selected simply by visual observation of each tile or by placing a light-sensing device (such as a photometer) in front of each tile and adjusting the power until the desired level of luminance is created. Alternatively, if the LED characteristics and manufacturing techniques can be tightly controlled, the preferred current draw for each tile may be pre-selected and used as the preferred current draw for each tile. This technique would allow a reduction in manufacturing time/costs as each tile would not require evaluation and measurement during manufacturing.

FIG. 5 shows a schematic of an exemplary control circuit. Throughout operation of the device the current draw for each tile is measured and the power to the specific tile may be increased or decreased depending on the current measurement. The LEDs 50 may be configured in any desired manner. Exemplary LED configurations would be those shown in FIGS. 3A, 3B, and 4. The control of the LED current levels may be added at pin location 51. A light sensing device (not shown) may also be used in an exemplary circuit to measure the luminance of the backlight throughout the life of the device. A single light sensing device may be used to sense the overall luminance level of the backlight, or multiple light sensing devices may be used to detect a specific tile or tiles which are displaying a decreased or increased level of luminance.

An exemplary embodiment may use a control integrated circuit from Supertex Inc. of Sunnyvale, Calif.; www.supertex.com. An exemplary integrated circuit from Supertex would be model number HV9910. The Application Note AN-H50 titled “Constant Off-time, Buck-based LED Drivers Using HV9910,” document A110204, is herein incorporated by reference in its entirety. Also, the technical datasheet for the HV9910 LED driver entitled “Universal High Brightness LED Driver,” document DSFP-HV9910 is herein incorporated by reference in its entirety.

Additionally, exemplary embodiments may contain a measurement of the forward voltage of the LED string to determine when a tile may need replaced. If using the circuit embodiment shown in FIG. 4, the forward voltage of each parallel block could be measured and compared to the other parallel blocks. This embodiment may set a threshold where the difference between the blocks is too great to be acceptable to the user, and the system can indicate that a tile needs replaced.

Having shown and described preferred embodiments, those skilled in the art will realize that many variations and modifications may be made to affect the described embodiments and still be within the scope of the claimed invention. Additionally, many of the elements indicated above may be altered or replaced by different elements which will provide the same result and fall within the spirit of the claimed invention. It is the intention, therefore, to limit the invention only as indicated by the scope of the claims.

What is claimed is:

1. A backlight assembly for a display comprising:
a mounting structure;
a plurality of tiles removably attached to said mounting structure;
a plurality of LEDs attached to each of said tiles;
electrical connections for each LED within each tile;
a means for controlling the current flow through the electrical connections of each tile; and
removable electrical connections for each tile.

2. The backlight assembly from claim 1 wherein:
said tiles are comprised of printed circuit boards (PCBs).

3. The backlight assembly from claim 2 wherein:
said PCBs are comprised of metal core PCBs.

4. The backlight assembly from claim 1 wherein:
said tiles are removable from the back of the display.

5. The backlight assembly of claim 1 wherein:
said means for controlling the current flow through the electrical connections of each tile comprises a pulse width modulating driver control integrated circuit.

6. The backlight assembly of claim 1 further comprising:
an inductor in series with said LEDs.

7. The backlight assembly of claim 1 wherein:
the electrical connections for the LEDs within each tile comprises a plurality of LED groups connected in series where each LED group comprises a plurality of LEDs connected in parallel.

8. A liquid crystal display (LCD) having a rear and front, said LCD comprising:
a backlight assembly in the rear of the display, comprising:
a mounting structure;
a plurality of tiles removably attached to said mounting structure, wherein each tile can be attached and detached from the mounting structure through the rear of said display;
a plurality of LEDs attached to each of said tiles;
electrical connections for each LED within each tile; and
removable electrical connections for each tile.
a means for controlling the current flow through the electrical connections of each tile; and
an LCD stack in the front of the display and aligned with said backlight assembly.

9. The backlight assembly from claim 8 wherein:
said tiles are comprised of printed circuit boards (PCBs).

10. The backlight assembly from claim 9 wherein:
said PCBs are comprised of metal core PCBs.

11. The backlight assembly of claim 8 wherein:
said means for controlling the current flow through the electrical connections of each tile comprises a pulse width modulating driver control integrated circuit.

12. The backlight assembly of claim 11 further comprising:
an inductor in series with said LEDs.

13. The backlight assembly of claim 1 wherein:
the electrical connections for the LEDs within each tile comprises a plurality of LED groups connected in series where each LED group comprises a plurality of LEDs connected in parallel.

14. A static display comprising:
a power source;
a mounting structure;
a plurality of tiles removably attached to said mounting structure, each tile comprising:
a first group of LEDs comprising a plurality of LEDs connected in parallel;
a positive conduction line connected to said power source and to said first group of LEDs;
a second group of LEDs comprising a plurality of LEDs connected in parallel, wherein said second group of LEDs is connected in series to said first group of LEDs; and
a negative conduction line connected to said second group of LEDs and returning to said power source;
a control box electrically removably connected to each tile, said control box comprising;
a means for controlling the current flow through the conduction lines of each tile; and
an image adapted to be illuminated by said LEDs.

15. The display of claim 14 further comprising:
a light diffusing element positioned between said image and said plurality of tiles.

16. The display of claim 14 wherein:
said means for controlling the current flow through the conduction lines of each tile comprises a pulse width modulating driver control integrated circuit.

17. The display of claim 14 wherein:
said tiles are comprised of printed circuit boards (PCBs).

18. The display of claim 17 wherein:
said PCBs are comprised of metal core PCBs.

19. The display of claim 14 wherein each tile further comprises:
a third group of LEDs comprising a plurality of LEDs connected in parallel; and
wherein said third group of LEDs is connected in series to said second group of LEDs and to said negative conduction line returning to said power source.

20. The display of claim 19 wherein each tile further comprises:
an inductor in series with said third group of LEDs and said power source.
